(19) United States
(12) Patent Application Publication
(10) Pub. No.: US 2021/0258494 A1
(43) Pub. Date: Aug. 19, 2021

(54) FLIGHT CONTROL METHOD AND AIRCRAFT

(71) Applicant: SZ DJI TECHNOLOGY CO., LTD., Shenzhen (CN)

(72) Inventor: Wei ZHANG, Shenzhen (CN)

(21) Appl. No.: 17/105,952

(22) Filed: Nov. 27, 2020

Related U.S. Application Data
(63) Continuation of application No. PCT/CN2018/089066, filed on May 30, 2018.

(51) Int. Cl. H04N 5/232; H04N 7/01; G05D 1/10; G05D 1/00

(52) U.S. Cl. CPC H04N 5/23299; H04N 7/0127; G05D 1/0094; G05D 1/101; H04N 5/23203

(57) ABSTRACT

The present disclosure provides a flight control method. The method includes controlling an imaging device on an aircraft to record a target object at a first frame rate on a first trajectory to obtain a first video, a flight speed of the aircraft on the first trajectory is not lower than a predetermined speed threshold. The method further includes converting the first video into a second video with a second frame rate.

### CROSS-REFERENCE TO RELATED APPLICATION

This application is a continuation application of International Application No. PCT/CN2018/089066, filed on May 30, 2018, the entire content of which is incorporated herein by reference.

### TECHNICAL FIELD

The present disclosure relates to a controller and an imaging method for imaging and automatically detecting the imaging position of a scene of interest.

### BACKGROUND

“Bullet time” special effect is a special effect scene that often appears in movies, advertisements, and games. “Bullet time” is generally used to freeze fast-moving pictures and create a visual effect of the freezing moment. The “bullet time” special effect is mainly obtained through special imaging techniques. The conventional imaging method includes first limiting an active range of a subject being imaged, setting a slide rail around the active range, then manually controlling a camera to slide quickly on the slide rail. In this process, the camera needs to be controlled at all times to aim at the subject being imaged. Therefore, the imaging of the “bullet time” special effect requires high level of cameraman's imaging skill, and also requires a lot of manpower and time to support the construction of hardware facilities (such as the slide rail).

The conventional imaging method needs to be improved such that a video with “bullet time” special effect can be created quickly and easily.

### SUMMARY

One aspect of the present disclosure provides a flight control method. The method includes controlling an imaging device on an aircraft to record a target object at a first frame rate on a first trajectory to obtain a first video, a flight speed of the aircraft on the first trajectory is not lower than a predetermined speed threshold. The method further includes converting the first video into a second video with a second frame rate.

Another aspect of the present disclosure provides an aircraft. The aircraft includes an imaging device; a processor; and a memory storing computer instructions. When executed by the processor, the computer instructions cause the processor to: control the imaging device to record a target object at a first frame rate on a first trajectory to obtain a first video, a flight speed of the aircraft on the first trajectory is not lower than a predetermined speed threshold; and convert the first video into a second video with a second frame rate.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a schematic structural diagram of a flight system according to an embodiment of the present disclosure.

FIG. 2 is a flowchart of a flight control method according to an embodiment of the present disclosure.

FIG. 3 is a schematic diagram of a principle of a curve algorithm according to an embodiment of the present disclosure.

FIG. 4 is a schematic diagram of a second trajectory scene according to an embodiment of the present disclosure.

FIG. 5 is a schematic diagram of a scene or a range of a first trajectory according to an embodiment of the present disclosure.

FIG. 6 is a flowchart of the flight control method according to an embodiment of the present disclosure.

FIG. 7 is a schematic structural diagram of an aircraft according to an embodiment of the present disclosure.

FIG. 8 is a schematic structural diagram of the aircraft according to an embodiment of the present disclosure.

### DETAILED DESCRIPTION OF THE EMBODIMENTS

The technical solutions provided in the embodiments of the present disclosure will be described below with reference to the drawings. However, it should be understood that the following embodiments do not limit the disclosure. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

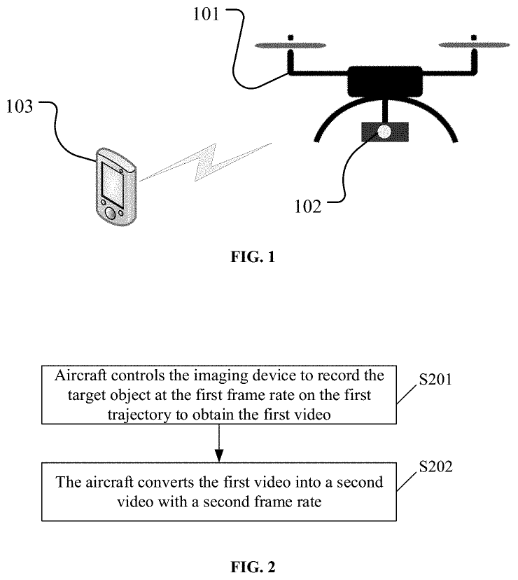

FIG. 1 is a schematic structural diagram of a flight system according to an embodiment of the present disclosure. The system includes an aircraft 101, a gimbal 102 disposed on the aircraft, and a ground control device 103 for controlling the aircraft 101 and/or the gimbal 102. The aircraft may include various types of UAV, such as a quadcopter UAV, a hexcoper UAV, etc. A flight trajectory can be planned for the aircraft in advance, such that the aircraft can fly based on the flight trajectory. In addition, the gimbal 102 disposed on the aircraft 101 may be a three-axis gimbal. That is, the attitude of the gimbal 102 can be controlled in the pitch, roll, and yaw axis, thereby determining the direction of the gimbal 102. As such, when the aircraft 101 is in a stationary of flying state, an imaging device or the like can complete tasks such as aerial photography of an imaging target in the direction desired by the user.

The aircraft 101 may include a flight controller, and the flight controller can establish a communication connection with the ground control device 103 through a wireless connection method (for example, a wireless connection method based on Wi-Fi, radio frequency communication, etc.). The ground control device 103 can be a controller with a rocker, which can control the aircraft based on an amount of the rocker movement. Alternatively, the ground control device 103 can be a smart device, such as a smart phone or a tablet. In this case, the aircraft 101 can be controlled to fly automatically by configuring the flight trajectory on a user interface (UI) or by somatosensory methods.

Referring to FIG. 2, an embodiment of the present disclosure provides a flight control method. The method will be described in detail below.

S201, the aircraft controls an imaging device to record a target object at a first frame rate on a first trajectory to obtain a first video.

More specifically, the flight speed of the aircraft on the first trajectory may not be lower than a predetermined speed threshold. The predetermined speed threshold may be a relatively high speed set in advance, and the specific speed can be set based on actual needs, for example, it can be set to 5 m/s, 10 m/s, etc. In addition, the flight speed not lowering than the predetermined speed threshold described here may be that the flight speed is maintained at or above the predetermined speed threshold. For example, if the predetermined speed threshold is 10 m/s, then the flight speed of the aircraft on the first trajectory may be maintained at 10 m/s or above 10 m/s. Further, the first frame rate in the embodiment of the present disclosure may also be a relatively high frame rate set in advance based on actual needs. For example, the first frame rate may be set to 120 fps, such that and the playback effect of the recorded video based on the first frame rate is relatively smooth.

Below are some possible scenarios of the target object.

In the first scenario, the aircraft may control the imaging device to record at will. In this case, the target object may refer to the scene in the imaging field of the imaging device, which may include people, vehicles, aircrafts, etc.

In the second scenario, the aircraft may determine which objects are included in the image based on information such as the contour characteristics and the tone characteristics in the image acquired by the imaging device. The user may instruct (e.g., by using a local control device to provide computer instructions) the aircraft which object (e.g., people, vehicles, aircrafts, etc.) to record, and the aircraft can record the object through the imaging device, where the object that the user instructs the aircraft to record may be the target object. In some embodiments, the target object may be remotely indicated by operating on the ground control device.

In some embodiments, controlling the imaging device on the aircraft to record the target object at the first frame rate on the first trajectory to obtain the first video may include controlling the imaging device on the aircraft to continuously track the target object on the first trajectory and controlling the imaging device to record the target object at the first frame rate to obtain the first video. Tracking the target object can make the target object appear in any position in the imaging field of the imaging device in real time, such as in a relatively central position of the imaging field of view of the imaging device. The following describes the implementation of tracking.

The aircraft can pre-store characteristic information of the target object (for example, features such as contour, brightness, chroma, etc.), search for the area where the characteristic information of the target object is present in the image acquired by the imaging device in real time, and determine which area includes the characteristic information, where the target object is in the area including the characteristic information. This process can be realized by using various algorithms, such as the tracking algorithm. Alternatively, the user can also select an area to be tracked on the image acquired by the imaging device based on an interactive method, and analyze the characteristics of the area, and then perform continuous tracking. It should be noted that if the target object is not in the center or close to the edge of the acquired image, the aircraft may further adjust the imaging angle of the imaging device, such that the target object may be constantly in the imaging field (or the relative center of the field of view) of the imaging device. The adjustment method may include, but are not limited to the following two methods. In the first method, when the imaging device is being carried by the gimbal of the aircraft, the pitch axis, yaw axis, and roll axis on the gimbal may be adjusted in real time to adjust the imaging angle of the imaging device, such that the imaging angle of the imaging device can be aligned to the target object. In addition, if the gimbal is not a three-axis gimbal, the gimbal may not be able to be adjusted to a desired direction. In this case, the attitude of the aircraft may be adjusted at the same time, that is, by adjusting the attitude of the aircraft and the angle of the gimbal together, the imaging device can be aligned to the target object. In the second method, if the imaging device is fixed on the aircraft and cannot be rotated, the aircraft may adjust its attitude in real time during the flight, such that the imaging angle of the imaging device fixed on the aircraft can be aligned to the target object.

The following are some possible scenarios of the first trajectory.

In the first scenario, the first trajectory may be a random trajectory of the aircraft.

In the second scenario, the first trajectory may be a part of the trajectory planned in advance, or a part of the trajectory in the part of the trajectory. If the first trajectory is a part of a planned second trajectory, then the aircraft controlling the imaging device on the aircraft to record the target object at the first frame rate on the first trajectory to obtain the first video may include the aircraft flying based on a pre-planned second trajectory and controlling the imaging device on the aircraft to record the target object at the first frame rate on the first trajectory to obtain the first video, where the distance from any point on the first trajectory to the target object may be within a predetermined interval. That is, the aircraft may fly based on the planned second trajectory, but may only record the target object in a segment of the first trajectory by using the imaging device, and the first trajectory may not be any part of the second trajectory. It should be understood that since the flight speed of the aircraft flying on the first trajectory needs to reach the predetermined speed threshold, the trajectory planned by the present disclosure not only includes the first trajectory, but also include additional trajectories. The additional trajectories can facilitate the acceleration buffering before the aircraft enters the first trajectory, thereby accelerating the speed to the predetermined speed threshold, and it also helps the aircraft to decelerate and buffer after flying the first trajectory in order to reduce the speed from the predetermined speed threshold. In addition, if the imaging distance is too close or too far, the imaging result will be poor. Therefore, by setting the distance from any point on the first trajectory to the target object within a predetermined interval, the quality of the acquired image can be ensured. For example, the predetermined interval may be preset as an interval of three to five meters.

In some embodiments, the first trajectory may include a plurality of segments. In which case, the plurality of first trajectories may be scattered on the second trajectory. In addition, the imaging device may use the first frame rate to acquire images on each of the first trajectories. Alternatively, the imaging device may use the first frame rate to acquired images on one (or some) of the first trajectories, while other first trajectories may use additional frame rate other than the first frame rate. For example, the additional frame rate may be less than the first frame rate.

It should be noted that the second trajectory may be a pre-planned trajectory (e.g., a straight trajectory). Alternatively, the second trajectory may be determined by the aircraft based on at least one of the starting point of the flight, and the moving speed, the moving direction, and the current position of the target object. That is, in the process of determining the second trajectory, the aircraft may use at least one piece of information from the starting point of the flight, and the moving speed, the moving direction, and the current position of the target object. In addition, other information may also be used, and other information is not limited in the present disclosure. For example, the second trajectory may be determined by the aircraft based on the starting point of the flight and the position of the target object, such that the starting position of the second trajectory may be the starting point of the flight and present a direction around the target object. Many conventional algorithms can achieve this goal. The following is an example, of a possible calculation method. First, the aircraft may determine a reference point based on a movement state of the target object. The movement state may include information such as moving speed, acceleration, and moving direction. Then the aircraft may determine a symmetry point based on the flight starting point of the aircraft and a target straight line, and the target straight line may be the straight line in which the target object moves. In some embodiments, the distance from the flight starting point to the target straight line may be equal to the distance from the symmetry point to the target straight line. In some other embodiments, the flight starting point may be axisymmetric with the symmetry point, and the symmetry axis may be the target straight line. There may be other relationships between the flight starting point and the symmetrical point, which are not listed here. Subsequently, the aircraft may determine the second trajectory based on the flight starting point, the reference point, and the symmetry point, such that the second trajectory may pass the flight starting point, the reference point, and the symmetry point, and the first trajectory may pass the reference point.

There are many methods for the aircraft to determine the second trajectory based on the flight starting point, the reference point, and the symmetry point. The following is an example of the implementation method using the Bezier curve planning algorithm.

B(t)=P₀*(1−t)³+3P₁*t*(1−t)²+3P₂*t²*(1−t)+P₃*t³ 1-1

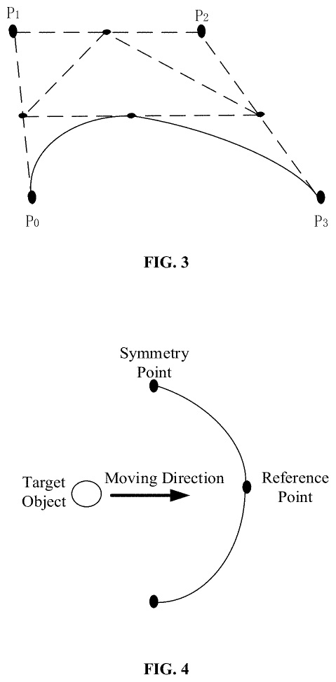

Refer to FIG. 3 and Formula 1-1. The curve B(t) represented by Formula 1-1 is the curve between points P₀ and P₃ calculated based on the Bezier curve planning algorithm, where t may be a known quantity of t∈[0,1], and a first constraint point Pi and a second constraint point P₂ may be two pre-configured quantities for adjusting the degree of curvature of the curve. In this embodiment, the flight starting point may be used as P₀ and the reference point may be used as P₃, and the curve between the flight starting point and the reference may be calculated based on Formula 1-1. Then the symmetry point may be set as P₀ and the reference point may be set as P₃, and the curve between the symmetry point and the reference point may be calculated based on Formula 1-1. Subsequently, the two obtained curves can be combined to obtain the second trajectory described above. FIG. 4 is a schematic diagram of a scene in which the second trajectory is calculate.

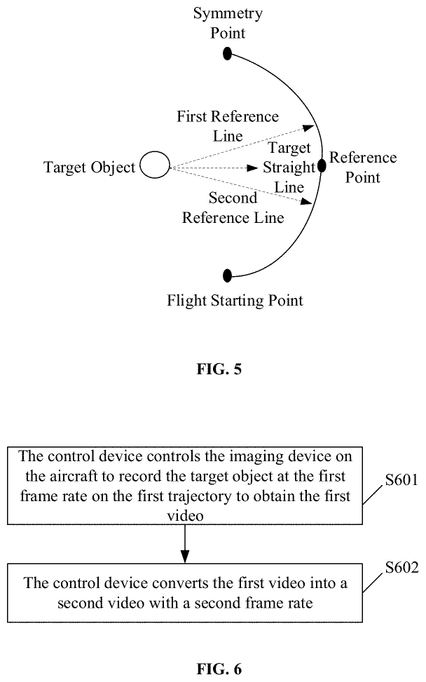

In some embodiments, as shown in FIG. 5, an angle between a first reference line and a first line, and an angle between a second reference line and the first line may be equal to a second angle threshold. The first reference line may be a connection line between one end of the first trajectory and the positon of the target object; the second reference line may be a connection line between the other end of the first trajectory and the position of the target object; and the first line may be a line between the reference point and the position of the target object. The part of the second trajectory sandwiched between the first reference line and the second reference line may be the first trajectory. Since the target object substantially moves toward the direction of the first trajectory, when the target object is captured on the first trajectory, it may be possible to capture as much detailed information of the target object as possible during the movement. It should be noted that the second angle threshold described here may be an angle set in advance as needed, which may be used to constrain the position of the first trajectory on the second trajectory.

For the ease of understanding, the “reference point” mentioned above will be described below. In some embodiments, the angle between the first line between the reference point and the position of the target object and the target straight line may be less than or equal to a first angle threshold. For example, if the first video needs to be captured from the top, bottom, side, and head-up angle, the first angle threshold may be controlled to achieve this goal. If the first video needs to be captured with a head-up effect, the following process may be used to determine the reference point. First, the aircraft may determine the position of the target object when the speed of the target object drops from high to a predetermined speed threshold based on the movement state of the target object. Subsequently, the aircraft may determine a point in the moving direction of the target object based on the movement state of the target object, such that the distance from the point to the position falls within the predetermined interval, then the determined point may be the reference point. It should be understood that since the reference point is on the first trajectory, the target object may be shot at or near the reference point. If the predetermined speed threshold is set to zero, the target object may be shot at or near the reference point when the moving speed drops to close to zero. In surfing scenes (or analogous images of jumping scenes), when the speed of the surfer (i.e., the target object) drops from high to close to zero, the image captured are generally very exciting. For surfing scenes, the entire operation process may include starting to track the surface in response to detecting the surfer having an upward speed while planning the second trajectory, and flying along the second trajectory to bypass the surfer. When the surfer's upward moving speed is quickly reduced to zero, the aircraft may fly in front of the surfer at high speed to observe the surfer's situation from as wide an angle as possible at the highest point of the surf.

In addition, it may also be possible that during the time period when the imaging device is recording the target object on the first trajectory, the moving speed of the target object has not dropped to a relative low speed, but has been maintained at a relatively high speed. Taking the race track scene as an example, during the continuous high-speed movement of the race car, the image of the race car moving at a high-speed can be captured on the first trajectory through the imaging device.

In some embodiments, when the aircraft obtains the second trajectory and flies based on the second trajectory, the aircraft may also adjust and optimize the un-flied second trajectory in real time based on the flight state of the aircraft and movement state of the target object, and continue to fly based on the adjusted and optimized second trajectory in time. When adjusting the second trajectory, the first trajectory, as a part of the second trajectory, may also be adjusted and optimized.

S202, the aircraft converts the first video into a second video with a second frame rate.

More specifically, the first video of the first frame rate may be converted into the second video of the second frame rate, and the first frame rate may be higher than the second frame rate. In some embodiments, the second frame rate may be at most ⅓ of the first frame rate. For example, the first frame rate may be 120 fps, and the second frame rate may be 30 fps. At this point, when the second video is played, the presentation angle of the target object will change rapidly, but the effect of the target object's movement change may be extremely slow, and the effect presented at this time is the “bullet time” special effect. It should be noted that even though the frame rate of the second video is greatly reduced compared with the first video, the playback effect of the second video may still be smooth. This is mainly because the first frame rate used when recording the first video is relatively high, therefore, even though the second frame rate is lower than the first frame rate, it is not too low to affect the smoothness of the video playback.

In the method shown in FIG. 2, the aircraft can fly on the first trajectory at high speed and record the first video at the first frame rate, and then convert the first video into the second video with a low frame rate, such that the second video may be presented with the “bullet time” special effect. Compared with the conventional technology where a slide rail needs to be built and a professional needs to control the imaging device in real time, the method of the present disclosure to obtain a video with the “bullet time” special effect is simpler and more efficient.

Referring to FIG. 6. An embodiment of the present disclosure further provides a flight control method. The flight control method will be described in detail below.

S601, a control device controls the imaging device on the aircraft to record the target object at the first frame rate on the first trajectory to obtain the first video.

More specifically, the (ground) control device can send a control instruction to the aircraft, and correspondingly, the aircraft receives the control instruction and execute the control based on the control instruction. The control performed may specifically include the aircraft controlling the imaging device on the aircraft to record the target object at the first frame rate on the first trajectory to obtain the first video. The method of the aircraft controlling the imaging device on the aircraft to record the target object at the first frame rate on the first trajectory to obtain the first video has been described in detail in the process at S201, which will not be repeated here.

S602, the control device converts the first video in a second video with a second frame rate.

More specifically, after the first video is captured by the imaging device on the aircraft, the first video may be sent by the aircraft to the (ground) control device. Correspondingly, the (ground) control device can convert the first video into the second video. That is, the original video data is collected by the aircraft, and the processing of the original data to obtain the video with the “bullet time” effect is done by the (ground) control device. In addition, the principle of converting the first video into the second video has been described in detail in the process at S202, which will not be repeated here.

The method embodiment of the present disclosure is described above, and the aircraft of the embodiment of the present disclosure will be described below.

Referring to FIG. 7, which is a schematic structural diagram of an aircraft according to an embodiment of the present disclosure. The aircraft includes a control module 701 and a conversion module 702.

The control module 701 may be used to control the imaging device on the aircraft to record the target object at the first frame rate on the first trajectory to obtain the first video, where the flight speed of the aircraft on the first trajectory may not be lower than a predetermined speed threshold.

The conversion module 702 may be configured to convert the first video into a second video with a second frame rate.

In some embodiments, the control module 701 controlling the imaging device on the aircraft to record the target object at the first frame rate on the first trajectory to obtain the first video may include flying based on a pre-planned second trajectory and controlling the imaging device on the aircraft to record the target object at the first frame rate on the first trajectory to obtain the first video, where the first trajectory may be a segment on the second trajectory, and the distance from any point on the first trajectory to the target object may be within a predetermined interval.

In some embodiments, the aircraft may further include a determination module. The determination module may be configured to determine the second trajectory based on at least one of the flight starting point, and the moving speed, the moving direction, and the current position of the target object before the control module 701 controls the aircraft to fly based on the second trajectory and controls the imaging device to record the target object at the first frame rate on the first trajectory to obtain the first video.

In some embodiments, the determination module determining the second trajectory based on at least one of the flight starting point, and the moving speed, the moving direction, and the current position of the target object may include determining the second trajectory based on the flight starting point and the position of the target object.

In some embodiments, the determination module determining the second trajectory based on the flight starting point and the position of the target object may include determining a reference point based on a movement state of the target object; determining a symmetry point based on the flight starting point of the aircraft and a target straight line, the target straight line may be a straight line in which the target object moves; and determining the second trajectory based on the flight starting point, the reference point, and the symmetry point, where the second trajectory may pass through the flight starting point, the reference point, and the symmetry point, and the first trajectory may pass through the reference point.

In some embodiments, the angle between the first line between the reference point and the position of the target object and the target straight line may be less than or equal to a first angle threshold.

In some embodiments, the determination module determining the reference point based on the movement state of the target object may include determining the position of the target object when the moving speed of the target object drops from a high moving speed to a predetermined speed threshold based on the movement state of the target object; and determining a point in the moving direction of the target object based on the movement state of the target object, such that the distance from the point to the position falls within the predetermined interval, then the determined point may be the reference point.

In some embodiments, the flight starting point may be axisymmetric with the symmetry point, and the symmetry axis may be the target straight line.

In some embodiments, an angle between a first reference line and a first line, and an angle between a second reference line and the first line may be equal to a second angle threshold. The first reference line may be a connection line between one end of the first trajectory and the positon of the target object; the second reference line may be a connection line between the other end of the first trajectory and the position of the target object; and the first line may be a line between the reference point and the position of the target object.

In some embodiments, the determination module determining the second trajectory based on the flight starting point, the reference point, and the symmetry point may include determining the second trajectory based on the flight starting point, the reference point, the symmetry point, a pre-configured first constraint point, and the pre-configured second constraint point, where the first constraint point and the second constraint point may be used to constrain the smoothness of the second trajectory.

In some embodiments, the control module controlling the imaging device on the aircraft to record the target object at the first frame rate on the first trajectory to obtain the first video may include controlling the imaging device on the aircraft to continuously track the target object on the first trajectory and controlling the imaging device to record the target object at the first frame rate to obtain the first video.

In the embodiment of the present disclosure, the aircraft can fly on the first trajectory at high speed and record the first video at the first frame rate, and then convert the first video into the second video with a low frame rate, such that the second video may be presented with the “bullet time” special effect. Compared with the conventional technology where a slide rail needs to be built and a professional needs to control the imaging device in real time, the method of the present disclosure to obtain a video with the “bullet time” special effect is simpler and more efficient.

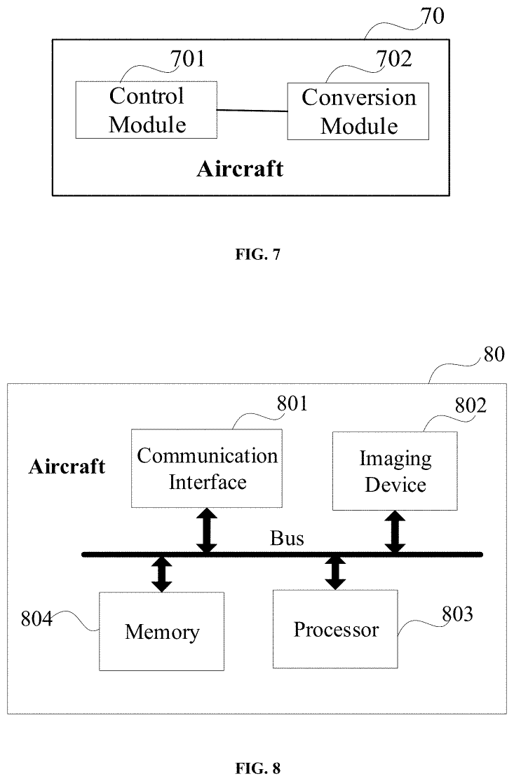

Referring to FIG. 8, which is a schematic structural diagram of an aircraft 80 according to an embodiment of the present disclosure. The aircraft in the embodiment of the present disclosure may be a single device, including a wired or wireless communication interface 801, an imaging device 802, a processor 803, a memory 804, and other modules such as a power supply. The wireless communication interface 801, imaging device 802, processor 803, memory 804, and other modules can be connected via a bus or other means. The aircraft can be connected to other device through a wireless or wired communication interface to send and receive control signals and perform corresponding processing.

The memory 804 may include, but is not limited to, a random storage memory (RAM), an erasable programmable read only memory (EPROM), or a compact disc read-only memory (CD-ROM). The memory 804 can be used to store related computer instructions and data.

The processor 803 may be one or more central processing units (CPU), or other processors (or chips) with information processing capabilities. When the processor 803 is a CPU, the CPU may be a single-core CPU or a multi-core CPU.

The imaging device 802 may be a camera or a camera module, or other devices that can be used to collect image information. The number of the imaging devices in the embodiment of the present disclosure may be one or more.

Further, the processor 803 in the aircraft 80 can be configured to read program codes stored in the memory 804 and perform the operation of controlling the imaging device to record the target object at the first frame rate on the first trajectory to obtain the first video, where the flight speed of the aircraft on the first trajectory may not be lower than a predetermined speed threshold; and converting the first video into a second video with a second frame rate.

In some embodiments, the processor 803 controlling the imaging device to record the target object at the first frame rate on the first trajectory to obtain the first video may include flying based on a pre-planned second trajectory and controlling the imaging device to record the target object at the first frame rate on the first trajectory to obtain the first video, where the first trajectory may be a segment on the second trajectory, and the distance from any point on the first trajectory to the target object may be within a predetermined interval

In some embodiments, the processor 803 may be further configured to determine the second trajectory based on at least one of the flight starting point, and the moving speed, the moving direction, and the current position of the target object before flying based on the second trajectory and controlling the imaging device to record the target object at the first frame rate on the first trajectory to obtain the first video.

In some embodiments, the processor 803 determining the second trajectory based on at least one of the flight starting point, and the moving speed, the moving direction, and the current position of the target object may include determining the second trajectory based on the flight starting point of the aircraft and the position of the target object

In some embodiments, the processor 803 determining the second trajectory based on the flight starting point of the aircraft and the position of the target object may include determining a reference point based on a movement state of the target object; determining a symmetry point based on the flight starting point of the aircraft and a target straight line, the target straight line may be a straight line in which the target object moves; and determining the second trajectory based on the flight starting point, the reference point, and the symmetry point, where the second trajectory may pass through the flight starting point, the reference point, and the symmetry point, and the first trajectory may pass through the reference point.

In some embodiments, the angle between the first line between the reference point and the position of the target object and the target straight line may be less than or equal to a first angle threshold.

In some embodiments, the processor 803 determining the reference point based on the movement state of the target object may include determining the position of the target object when the moving speed of the target object drops from a high moving speed to a predetermined speed threshold based on the movement state of the target object; and determining a point in the moving direction of the target object based on the movement state of the target object, such that the distance from the point to the position falls within the predetermined interval, then the determined point may be the reference point.

In some embodiments, the flight starting point may be axisymmetric with the symmetry point, and the symmetry axis may be the target straight line.

In some embodiments, an angle between a first reference line and a first line, and an angle between a second reference line and the first line may be equal to a second angle threshold. The first reference line may be a connection line between one end of the first trajectory and the positon of the target object; the second reference line may be a connection line between the other end of the first trajectory and the position of the target object; and the first line may be a line between the reference point and the position of the target object.

In some embodiments, the processor 803 determining the second trajectory based on the flight starting point, the reference point, and the symmetry point may include determining the second trajectory based on the flight starting point, the reference point, the symmetry point, a pre-configured first constraint point, and the pre-configured second constraint point, where the first constraint point and the second constraint point may be used to constrain the smoothness of the second trajectory.

In some embodiments, the processor 803 controlling the imaging device to record the target object at the first frame rate on the first trajectory to obtain the first video may include controlling the imaging device to continuously track the target object on the first trajectory and controlling the imaging device to record the target object at the first frame rate to obtain the first video.

In the embodiment of the present disclosure, the aircraft can fly on the first trajectory at high speed and record the first video at the first frame rate, and then convert the first video into the second video with a low frame rate, such that the second video may be presented with the “bullet time” special effect. Compared with the conventional technology where a slide rail needs to be built and a professional needs to control the imaging device in real time, the method of the present disclosure to obtain a video with the “bullet time” special effect is simpler and more efficient.

An embodiment of the present disclosure further provides a computer-readable storage medium. The computer-readable storage medium can store computer instructions that, when executed by the processor, can implement the method workflow shown in FIG. 2 or FIG. 6.

The technical solution of the present disclosure have been described by using the various embodiments mentioned above. However, the technical scope of the present disclosure is not limited to the above-described embodiments. It should be obvious to one skilled in the art that various modifications and improvements may be made to the embodiments. It should also be obvious from the scope of claims of the present disclosure that thus modified and improved embodiments are included in the technical scope of the present disclosure.

It should be understood that the foregoing embodiments are merely intended for describing the technical solutions of the present disclosure instead of limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. A flight control method, comprising:
controlling an imaging device on an aircraft to record a target object at a first frame rate on a first trajectory to obtain a first video, a flight speed of the aircraft on the first trajectory is not lower than a predetermined speed threshold; and
converting the first video into a second video with a second frame rate.

2. The method of claim 1, wherein controlling the imaging device on the aircraft to record the target object at the first frame rate on the first trajectory to obtain the first video includes:
flying the aircraft based on a second trajectory and controlling the imaging device on the aircraft to record the target object at the first frame rate on the first trajectory to obtain the first video, the first trajectory being a part of the second trajectory, and a distance from any point on the first trajectory to the target object being within a predetermined interval.

3. The method of claim 2, before flying the aircraft based on the second trajectory and controlling the imaging device to record the target object at the first frame rate on the first trajectory to obtain the first video, further includes:
determining the second trajectory based on one or more of a flight starting point, a moving speed, a moving direction, or a current position of the target object.

4. The method of claim 3, wherein determining the second trajectory based on one or more of the flight starting point, the moving speed, the moving direction, or the current position of the target object includes:
determining the second trajectory based on the flight starting point and the current position of the target object.

5. The method of claim 4, wherein determining the second trajectory based on the flight starting point and the current position of the target object includes:
determining a reference point based on a moving state of the target object;
determining a symmetry point based on the flight starting point of the aircraft and a target straight line, the target straight line being a straight line where the target object is positioned; and
determining the second trajectory based on the flight starting point, the reference point, and the symmetry point, the second trajectory crossing the flight starting point, the reference point and the symmetry point, and the first trajectory crossing the reference point.

6. The method of claim 5, wherein:
an angle between a first line between the reference point and the position of the target object and the target straight line is less than or equal to a first angle threshold.

7. The method of claim 5, wherein determining the reference point based on the moving state of the target object includes:
determining a position of the target object when the moving speed of the target object drops from a high speed to the predetermined speed threshold based on the moving state of the target object; and
determining a point in the moving direction of the target object based on the moving state of the target object where a distance from the point to the position falls within the predetermined interval, the determined point being the reference point.

8. The method of claim 5, wherein:
the flight starting point is axisymmetric with the symmetry point, and a symmetry axis is the target straight line.

9. The method of claim 5, wherein:
an angle between the first reference line and the first line, and an angle between the second reference line and the first line are equal to a second angle threshold, the first reference line being a line connecting one end of the first trajectory to the position of the target object, the second reference line being a line connecting another end of the first trajectory to the target object, the first line being a line between the reference point and the position of the target object.

10. The method of claim 5, wherein determining the second trajectory based on the flight starting point, the reference point, and the symmetry point includes:
determining the second trajectory based on the flight starting point, the reference point, the symmetry point, a pre-configured first constraint point, and a pre-configured second constraint point, the first constraint point and the second constraint point being used to constrain a smoothness of the second trajectory.

11. The method of claim 1, wherein controlling the imaging device on the aircraft to record the target object at the first frame rate on the first trajectory to obtain the first video includes:
controlling the imaging device on the aircraft to continuously track the target object on the first trajectory and controlling the imaging device to record the target object at the first frame rate to obtain the first video.

12. An aircraft, comprising:
an imaging device;
a processor; and
a memory storing computer instructions that, when executed by the processor, causes the processor to:
control the imaging device to record a target object at a first frame rate on a first trajectory to obtain a first video, a flight speed of the aircraft on the first trajectory is not lower than a predetermined speed threshold; and
convert the first video into a second video with a second frame rate.

13. The aircraft of claim 12, wherein the processor controlling the imaging device to record the target object at the first frame rate on the first trajectory to obtain the first video includes:
flying the aircraft based on a second trajectory and controlling the imaging device on the aircraft to record the target object at the first frame rate on the first trajectory to obtain the first video, the first trajectory being a part of the second trajectory, and a distance from any point on the first trajectory to the target object being within a predetermined interval.

14. The aircraft of claim 13, wherein the processor is further configured to:
determine the second trajectory based on one or more of a flight starting point, a moving speed, a moving direction, or a current position of the target object before flying based on the second trajectory and controlling the imaging device to record the target object at the first frame rate on the first trajectory to obtain the first video.

15. The aircraft of claim 14, wherein the processor determining the second trajectory based on one or more of the flight starting point, the moving speed, the moving direction and the current position of the target object includes:
determining the second trajectory based on the flight starting point of the aircraft and the current position of the target object.

16. The aircraft of claim 15, wherein the processor determining the second trajectory based on the flight starting point of the aircraft and the current position of the target object includes:
determining a reference point based on a moving state of the target object;
determining a symmetry point based on the flight starting point of the aircraft and a target straight line, the target straight line being a straight line where the target object is positioned; and
determining the second trajectory based on the flight starting point, the reference point, and the symmetry point, the second trajectory crossing the reference point and the symmetry point, and the first trajectory crossing the reference point.

17. The aircraft of claim 16, wherein:
an angle between a first line between the reference point and the position of the target object and the target straight line is less than or equal to a first angle threshold.

18. The aircraft of claim 17, wherein the processor determining the reference point based on the moving state of the target object includes:
determining a position of the target object when the moving speed of the target object drops from a high speed to the predetermined speed threshold based on the moving state of the target object; and
determining a point in the moving direction of the target object based on the moving state of the target object where a distance from the point to the position falls within the predetermined interval, the determined point being the reference point.

19. The aircraft of claim 16, wherein:
the flight starting point is axisymmetric with the symmetry point, and a symmetry axis is the target straight line.

20. The aircraft of claim 16, wherein:
an angle between the first reference line and the first line, and an angle between the second reference line and the first line are equal to a second angle threshold, the first reference line being a line connecting one end of the first trajectory to the position of the target object, the second reference line being a line connecting another end of the first trajectory to the target object, the first line being a line between the reference point and the position of the target object.
